(19) United States
(12) Patent Application Publication
(10) Pub. No.: US 2014/0340872 A1
(43) Pub. Date: Nov. 20, 2014

(54) Bathing Installation Fitting With Ring Structure And Seal

(71) Applicant: Balboa Water Group, Inc., Tustin, CA (US)

(72) Inventor: Graham J. Campbell, Stevenson Ranch, CA (US)

(73) Assignee: Balboa Water Group, Inc., Tustin, CA (US)

(21) Appl. No.: 13/897,316

(22) Filed: May 17, 2013

(51) Int. Cl. A61H 33/00; F21V 31/00; F21V 33/00

(52) U.S. Cl. CPC A61H 33/6063; F21V 33/004; F21V 31/005; A61H 2201/0111
USPC 362/96; 4/696; 29/525.11

(57) ABSTRACT

A fitting for through hole mounting to a panel structure in a bathing installation includes a fitting body structure including a body portion configured to extend through a mount opening and a transverse flange portion having an outer size larger than the mount opening to overlaps the panel structure surrounding the mount opening. A nut engages a portion of the body. A ring structure is positioned between the nut and the panel structure, and has an inner opening with a dimension larger than a diameter of the nut and larger than a dimension of the mount opening, and fits between the nut and the panel structure. A seal is disposed within a cavity defined by the ring structure, the panel structure, the fitting body portion and the nut to provide a water-tight seal.

### BACKGROUND

Bathing installations such as spas, pools, whirlpool baths and the like typically have fittings installed in openings in one or more walls of the water tub. The fittings can include, by way of example only, water jets, air jets, lights, controls, suction fittings, drains and the like. Sealing the installed fittings against water intrusion or leakage is a problem, often exacerbated by irregularities in the tub wall, which may be fabricated of fiberglass. Gaskets can be used, but can require proper assembly and careful tightening of fastening nuts.

### BRIEF DESCRIPTION OF THE DRAWINGS

Features and advantages of the disclosure will readily be appreciated by persons skilled in the art from the following detailed description when read in conjunction with the drawing wherein:

FIG. 1 is an exploded isometric view of an exemplary embodiment of a fitting assembly for a bathing installation.

FIG. 2 is a cross-section view of a fitting assembly as in FIG. 1, assembled in place but without a seal structure.

FIG. 3 is an isometric front view of a ring structure of the fitting assembly of FIG. 1.

FIG. 4 is an isometric back view of the ring structure of FIG. 3.

FIG. 5 is a cross-section view of the ring structure of FIG. 3.

FIG. 6 is a cross-section view similar to that of FIG. 2, but with a seal structure.

FIG. 7 is an exploded isometric view of another embodiment of a fitting assembly for a bathing installation, using a ring structure as shown in FIGS. 3 and 4.

FIG. 8 is a cross-sectional view of a fitting assembly as in FIG. 7.

### DETAILED DESCRIPTION

In the following detailed description and in the several figures of the drawing, like elements are identified with like reference numerals. The figures may not be to scale, and relative feature sizes may be exaggerated for illustrative purposes.

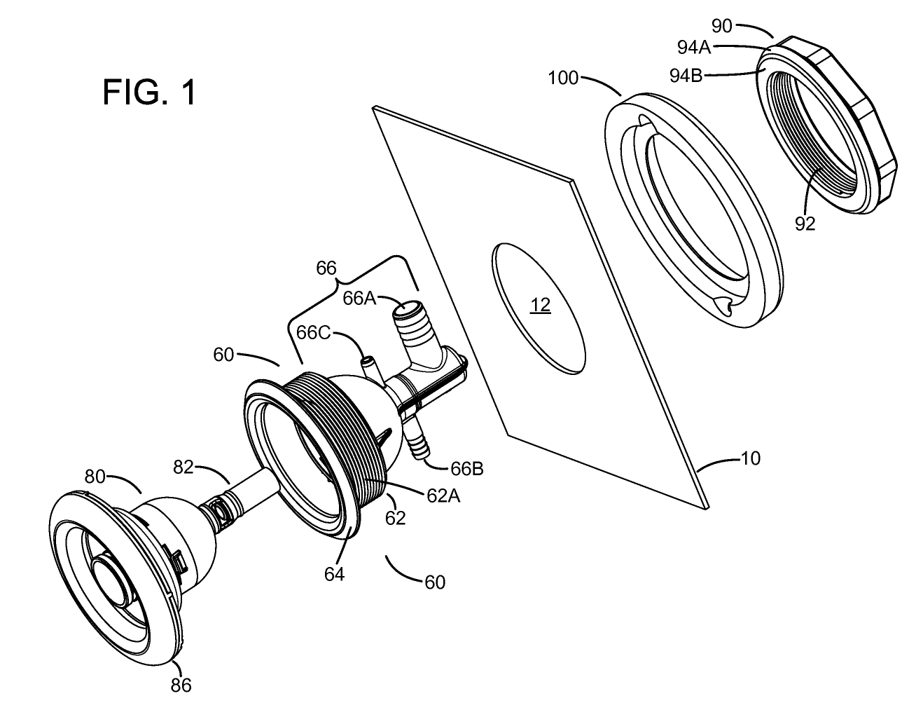

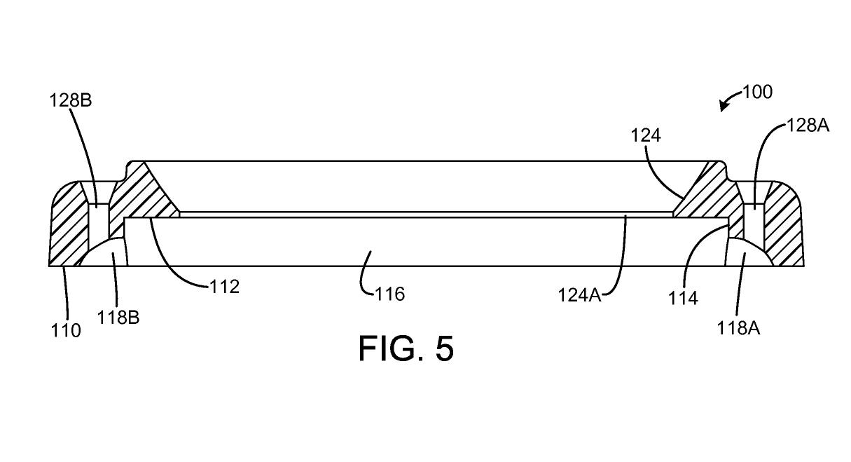

A fitting assembly for a bathing installation is described, which is configured for assembly to a wall structure of the bathing installation, and includes a novel water seal arrangement. An exemplary embodiment is illustrated in FIGS. 1-6. Here, the fitting assembly 50 is a jet assembly configured for assembly to a wall structure 10 of a bathing installation. The assembly 50 in this example includes a jet body 60 which includes a generally cylindrical body portion 62 with exterior threads 62A, a flange portion 64, and a backside portion 66. In other embodiments, the fitting can be other types of structures, such as diverter valves, air controls, lights, control panels, aroma therapy canisters, speakers and water features, by way of example only.

The jet body 60 may be fabricated from a translucent or transparent material such as clear ABS, clear PVC, clear acrylic or clear polycarbonate. In an exemplary embodiment, the jet body is an integral one-piece structure, and includes a water inlet port nipple 66A formed at one end of the jet body, and a flange portion 64 formed at the opposite end of the jet body. The flange portion has an outer diameter larger than the opening 12 defined in the wall structure 10. The water inlet nipple 66A has a passageway in fluid communication with the jet body internal open channel or plenum 60B. The water inlet nipple is configured for connection to a water line connected to a bathing installation pump, so that water may be pumped through the jet into the tub. The jet body flares outwardly to form a jet body cavity 60C of larger diameter than that of cavity 60B, which receives the central portion of an escutcheon and any jet fitting such as an eyeball or other water-directing feature, examples of which are well known in the bathing installation art.

A threaded nut 90 is configured to be threaded onto the threaded region 62 of the jet body 60, and secure the jet body 60 in place against the wall 10 by drawing the flange portion tightly against the wall. Alternatively, another attachment device may be used instead of a threaded nut, e.g. a slip or interference fit device. A ring structure 100, with the nut 90, jet body 60 and the wall 10, defines a cavity filled with a sealant material 130. In an exemplary embodiment, the ring structure 100 may also function to compensate for undulations in the tub wall.

The jet body 60 in this example includes an air inlet nipple 66B and a light receptacle or nipple 66C formed integrally with the body. The air inlet nipple 66B defines a passageway in fluid communication with opening 64B formed through the jet body. The air inlet nipple 66B is configured for tubing connection to an air source or air pump. For example, the nipple 66B may be connected to the atmosphere through a valve. This allows the water flowing through the jet to be conditioned with air bubbles entrained in the water flow.

The light receptacle nipple 66C has a passageway formed therein to provide a receptacle, which terminates in the jet body wall 60C. A light source such as an incandescent bulb, LED or optical fiber connected to a remotely located light source is disposed in the light receptacle. It will be apparent that light emitted by light source installed in the nipple receptacle will pass through the jet body wall 60C, if the jet body is fabricated of a transparent or translucent material. In this regard, the jet body and assembly 80 may be similar to the lighted fittings described, for example, in US Published Application 20120192348, the entire contents of which are incorporated herein by this reference.

The exemplary fitting assembly 50 further includes a jet barrel assembly 80. The assembly 80 includes a barrel structure 82 which is configured for insertion into the jet body channel 60B, and an escutcheon 86 which is attached to a first end portion of the barrel structure 82, e.g. by one or more clip portions, and which snap-fits into a corresponding slot formed in the barrel end portion. Other connection means may alternatively be used for connection of the escutcheon to the barrel, e.g. threads. In an exemplary embodiment, the barrel 82 is fabricated of a translucent or transparent material, such as clear or translucent ABS or PVC. The escutcheon 86 can be fabricated of an opaque or a transparent or translucent material, such as clear or opaque ABS, polycarbonate, acrylic or ASA (as an opaque material).

In another, non-lighted embodiment, the light receptacle can be omitted, and the jet body and parts fabricated of an opaque material.

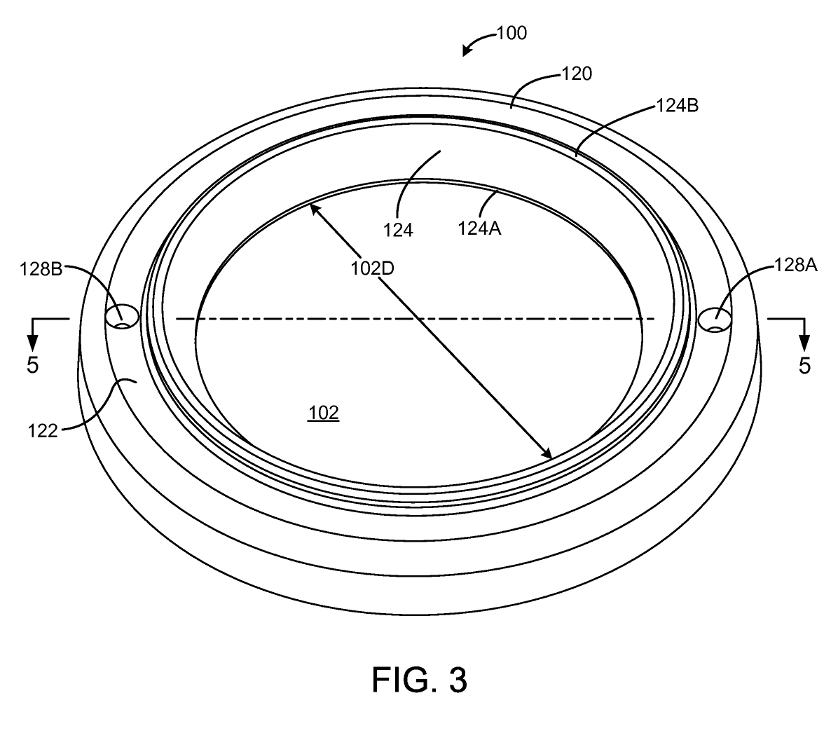

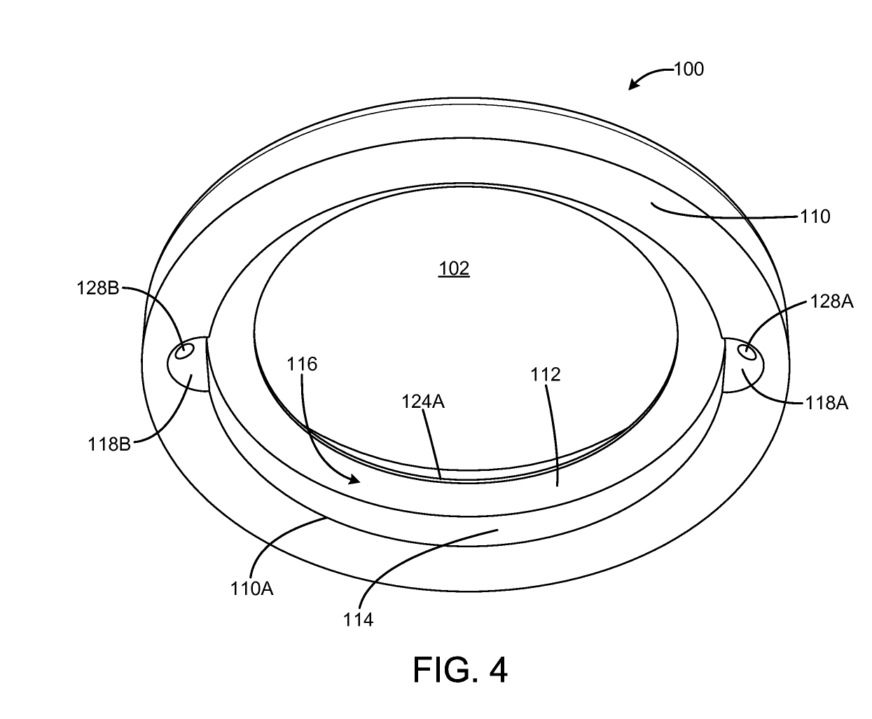

The fitting 50 includes a ring structure 100 shown in isolation in FIGS. 3-5, and is configured to fit between the nut 90 at the backside of the fitting and the back surface of the tub wall structure. The ring structure 100 may be fabricated as an injection-molded unitary part, e.g. from ABS, polycarbonate, acrylic, PVC or ASA. The ring structure has an inner opening 102 sized to be larger than the mount opening defined in the panel structure, and larger than the outer diameter of the threaded portion of the fitting body. The ring structure is characterized by a first side indicated generally indicated as 110 (FIG. 3) facing the tub wall, and a second side generally indicated as 120 (FIG. 4) facing away from the tub wall. The second side 120 has an outer generally flat or planar peripheral surface 122, and defines a beveled, angled surface 124 transitioning to an inner edge 124A at the inner opening 102. The outer edge 124B of the angled surface 124 is positioned above the surface 122 in this exemplary embodiment.

The first side 110 of the compensation ring structure 100 has a generally flat outer peripheral surface 110 configured to contact an inside or back surface of the tub panel structure. The rear surface of the wall of the tub panel into which the fitting is to be installed may be rough and uneven. The first side also has an inner periphery surface 112 positioned above the outer peripheral surface 110. A vertical peripheral wall 114 extends from the interior edge 110A of the surface 110 and the outer edge 112A of the inner peripheral surface 112, to form a recess 116.

First and second through openings 128A and 128B are formed through the outer periphery of the ring structure 100, at opposed sides of the ring. In an exemplary embodiment, the openings are spaced apart 180 degrees, although the spacing can vary depending on the requirements of the particular application. On the bottom side, the openings terminate in relieved areas 118A, 118B, which communicate with the recess 116.

The central opening 102 of the ring 100 is over-sized relative to the jet body threaded portion 62, and does not contact the body 60 in this exemplary embodiment. Turning the ring 100 will not cause the ring to engage the body 60 or draw the flange portion 64 toward the ring 100.

The nut 90 includes threads 92 sized to engage the threads 62A of the threaded portion 62 of the jet body 60. The nut has a peripheral angled surface 94A, extending outwardly from flat surface 94B and spaced from the threads 62A. The angular orientation of surface 94A generally matches that of surface 124 of the ring structure 100. The respective surfaces may define complementary 45 degree angles from a center axis of the fitting assembly, although other angular orientations may alternatively be employed. The respective surfaces 94A and 124 may take other forms, such as complementary curved surfaces, e.g. convex/concave surfaces. With the ring structure positioned to surround the opening in the wall structure, the nut surface 94A is brought into contact with surface 124 as the nut is advanced toward the ring, and eventually applies a compressive force against the ring surface 124. The flat surface 94B of the nut 90 essentially closes the gap between the edge 124A of the ring 100 and the fitting body. The respective facing surfaces 124 and 94A of the ring and nut allow compensation movement of the ring as the nut is tightened, so that the surface 110 may orient in a cocked relationship relative to the flange structure 64, depending on the roughness or smoothness of the rear wall surface. If the wall surface is uneven, the surface 110 may not be parallel to the flange surface of the flange structure 64, yet the nut 90 can be tightened against the ring structure 100 without causing the flange structure 64 to orient in a cocked relationship relative to the front surface of the wall structure.

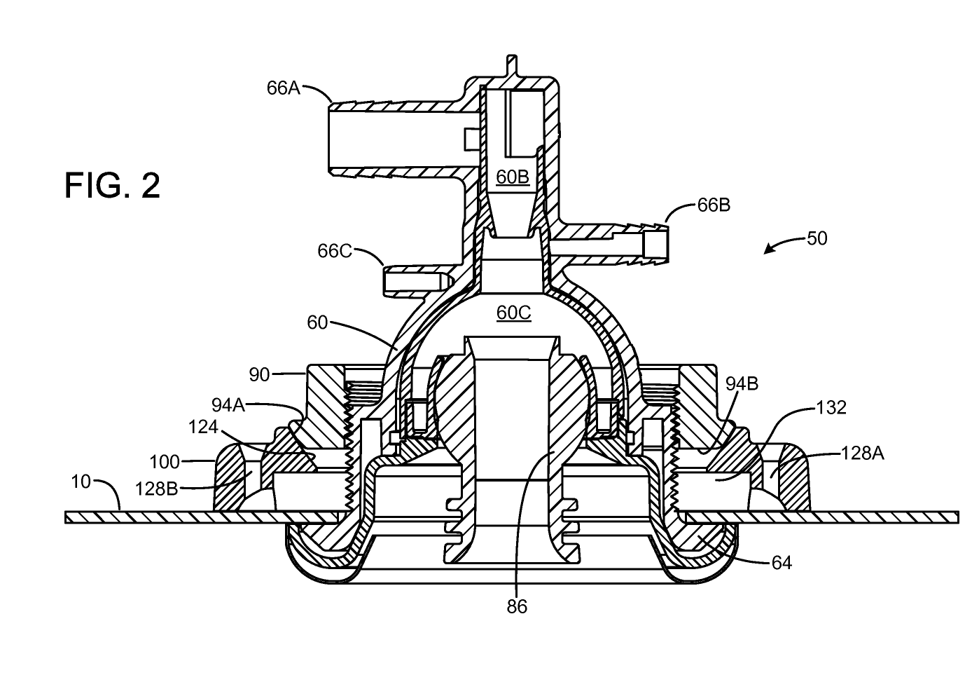

FIG. 2 illustrates in cross-section the fitting assembly including the body 60, nut 90 and ring 100 assembled to the wall 10. A circumferential cavity 132 includes the recess 116, and is defined by surfaces of the ring 100, a peripheral surface of the wall structure 10, surface 94B of the nut 90 and outer peripheral surfaces of the body portion 62 of the body 60.

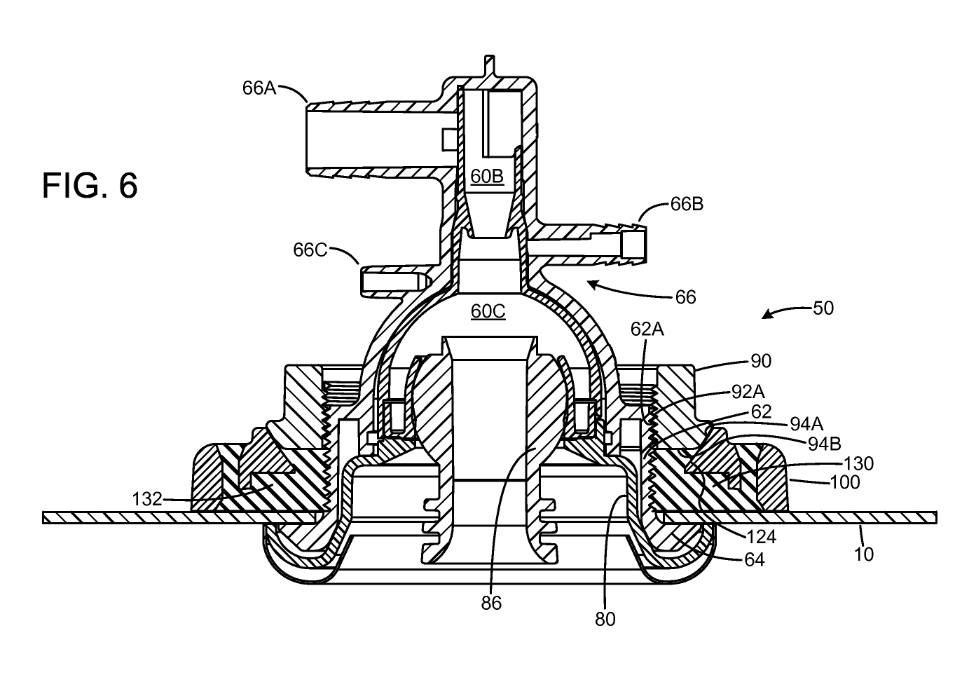

To provide a water seal for the fitting and prevent leakage of the bath water through the wall opening, a seal material in liquid form is dispensed through one of openings 128A or 128B, and fills the cavity 132, as indicated in FIG. 6. The seal material can be dispensed or injected until the recess is filled, indicated e.g. by an excess amount appearing at the other opening 128B or 128A. The seal material may be one which cures to a hardened or solid state after being injected into the recess, to form seal 130. The seal in this exemplary embodiment is formed in place, after the ring structure and the nut have been assembled to the fitting body (as shown in FIG. 2), and the nut tightened on the fitting body. Exemplary seal materials suitable for the purpose as formed-in-place seals include silicone, RTV (room temperature vulcanizing) silicone, or other material which may be injected into the recess and then cure in place. In an exemplary embodiment, manual or pneumatic silicone guns may be used to inject the liquid material into one opening 128A or 128B.

The seal 130 in this exemplary embodiment encapsulates the adjacent edge of the wall 10, to seal the fitting against water leakage around the opening 12 as well as the interfaces between the nut and the ring, and the nut and the body portion. (FIG. 6). The seal arrangement provides additional advantages, in that the nut need not be tightened as tightly as would be the case with conventional gasket seals. The seal material can better seal against water intrusion, since the liquid form of the material may enter into the threaded engagement between the nut and the jet body, and fill any imperfections in the adjacent back surface of the wall surrounding the opening. Also, a gasket need not be used between the flange 64 of the body 60 and the wall surface surrounding the opening 12, as in some conventional fittings.

Another aspect of the invention is directed to a method for mounting and sealing a fitting in a mount opening in a panel structure in a bathing installation. The method includes in an exemplary embodiment:
positioning a fitting body portion of a fitting body structure through the mount opening in the panel structure, the fitting body structure having a transverse flange portion with an outer size larger than the mount opening, so that the flange portion overlaps and contacts the panel structure surrounding the mount opening with the fitting body structure installed in the mount opening;
positioning a compensation ring structure onto the body portion of the fitting body structure from a panel structure side opposite the flange portion, the ring structure having an inner opening with a dimension larger than a size of the body portion;
engaging a nut structure with the body portion of the fitting body structure from the panel structure side opposite the flange portion, the nut having a peripheral engagement surface;
bringing the nut structure into contact with the ring structure such that the first surface of the ring structure contacts the peripheral engagement surface of the nut, so that a circumferential cavity is defined by the ring structure, a peripheral surface of the wall structure, the nut and outer peripheral surfaces of the body portion; and
dispensing a seal material through an opening in the ring structure into the cavity in a liquid state and allowing the seal material to cure in place to a solid state, to provide a water-tight seal.

In another embodiment, the seal structure may be pre-formed, e.g. as an elastomeric ring structure, sized to be compressed within the cavity 132 (FIG. 2) as the ring is positioned against the wall structure and tightly fit against the outer periphery of the jet body and the fitting body.

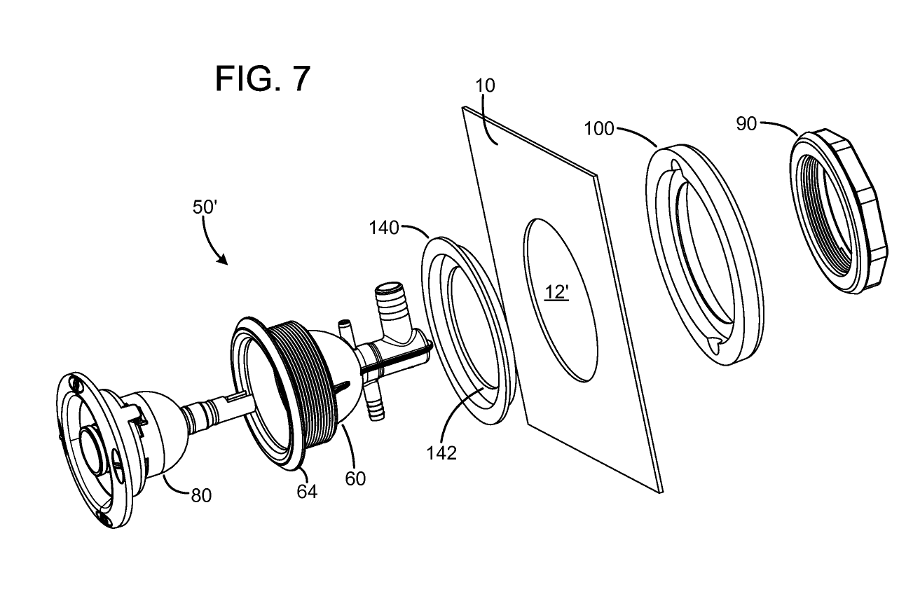

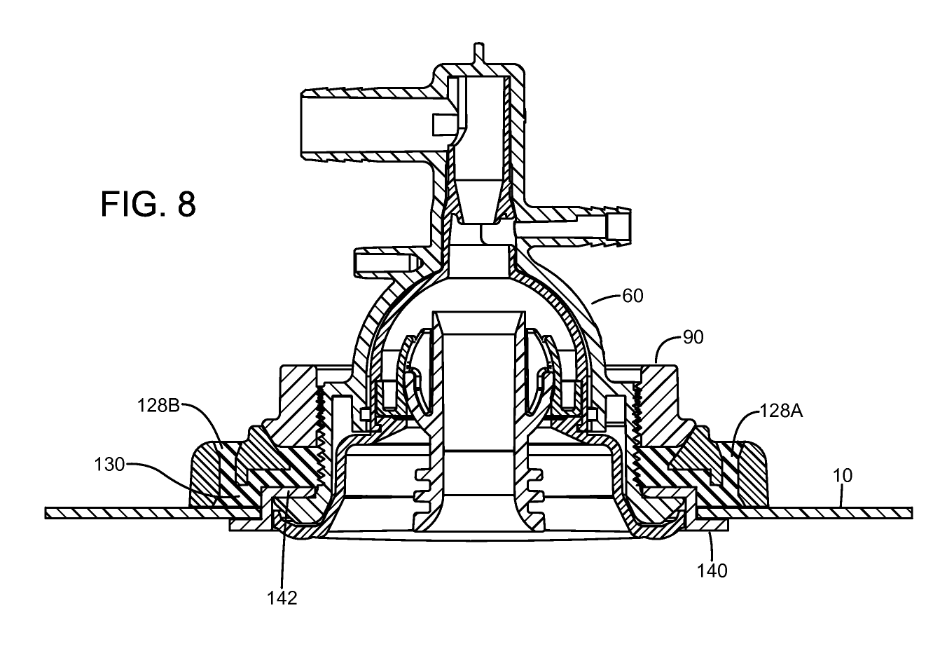

FIGS. 7 and 8 illustrate another embodiment 50′ of a fitting for a bathing installation. This exemplary embodiment includes a jet (or other fitting) identical to that described above regarding FIGS. 1-5, and adds a flange member 140 which fits into opening 12′ formed in the wall 10, so that the wall structure includes the wall 10 and flange member 140. The opening 12′ is slightly larger than the opening 12 of the embodiment of FIGS. 1-5 to accept the flange 140. The flange may be fabricated of a plastic or metal material, and defines an interior shelf 142 which supports the flange 64 of the jet body. The interior shelf 142 is received within the recess 116 (FIG. 4) defined by the ring 100, with sufficient clearance within the recess to allow the seal material to flow over the flange and shelf 142. FIG. 8 shows the fitting in a fully assembled condition, after the seal material 130 has been dispensed into the ring 100 through one of ports 128A or 128B. The seal has encapsulated the shelf 142, and the adjacent edge of the wall 10, to seal the fitting against water leakage around the opening 12′ as well as the interface between the wall edge and the flange member, and the interfaces between the nut and the ring and the ring and the wall.

The flange member 140 provides an emulation of a recess, molded or formed in the wall structure. The flange member may be fabricated as a stamped metal part or molded plastic.

Although the foregoing has been a description and illustration of specific embodiments of the subject matter, various modifications and changes thereto can be made by persons skilled in the art without departing from the scope and spirit of the invention.

What is claimed is:

1. A fitting for through hole mounting to a panel structure in a bathing installation, comprising:
a fitting body structure including a body portion configured to extend through a mount opening in the panel structure and having a threaded portion, and a transverse flange portion having an outer size larger than the mount opening, so that the flange portion overlaps the panel structure surrounding the mount opening with the fitting body structure installed in the mount opening;
a threaded nut for threaded engagement with the threaded portion of the fitting body structure, the threaded nut having a peripheral engagement surface displaced from threads of the nut;
a ring structure having an inner opening with a dimension larger than a diameter of the threads of the nut and larger than a dimension of the mount opening, the ring configured to fit between the nut and the panel structure with the nut engaged on the fitting body structure, and characterized by a first side facing the panel structure, and a second side facing away from the panel structure, the second side defining a first surface transitioning to an inner edge at the inner opening, the first side having a generally flat outer peripheral surface configured to contact a surface of the panel structure, an inner peripheral surface spaced from the outer peripheral surface, and an outer peripheral wall forming an interior recess;
a cavity defined by the recess, a peripheral surface of the wall structure, the nut and outer peripheral surfaces of the body portion; and
a seal within the cavity to provide a water-tight seal.

2. The fitting of claim 1, wherein:
the ring structure further includes at least one through opening communicating with the recess and formed through an outer periphery of the ring structure; and
the seal comprises a seal material dispensed through the at least one opening into the cavity in a liquid state and cured in place to a solid state.

3. The fitting of claim 2, wherein the seal material comprises a silicone.

4. The fitting of claim 2, wherein the seal material fills the cavity.

5. The fitting of claim 1, wherein:
the first surface of the ring structure and the peripheral engagement surface of the nut are complimentary surfaces configured to allow compensation movement of the ring structure as the nut is engaged with the body and turned to draw towards the panel structure and compensate for irregularities in the panel structure so that the flange portion is fitted to the panel structure.

6. The fitting of claim 1, wherein the panel structure consists of a wall in the bathing installation.

7. The fitting of claim 1, wherein the panel structure includes a wall in the bathing installation and a flange structure positioned in an opening in the wall with the mount opening formed in the flange structure, the flange structure cooperating with the wall to emulate a recess in a bathing installation wall.

8. The fitting of claim 1, wherein the fitting body is fabricated of a transparent or translucent material, and includes a light receptacle configured to hold a light source and provide an illumination effect.

9. The fitting of claim 1, wherein the fitting body structure is a jet body, and includes a water inlet port.

10. The fitting of claim 1, wherein the seal is a formed-in-place seal structure.

11. A fitting for through hole mounting to a panel structure in a bathing installation, comprising:
a fitting body structure including a body portion configured to extend through a mount opening in the panel structure, and a transverse flange portion having an outer size larger than the mount opening, so that the flange portion overlaps and contacts the panel structure surrounding the mount opening with the fitting body structure installed in the mount opening;
a nut sized for engagement with the body portion of the fitting body structure from a panel structure side opposite the flange portion, the nut having a peripheral engagement surface;
a compensation ring structure having an inner opening with a dimension larger than a diameter of the nut and larger than a dimension of the mount opening, the ring structure configured to fit between the nut and the panel structure with the nut engaged on the fitting body structure, the ring structure including a first side and a second side, the second side defining a first surface, the first side having an outer peripheral surface configured to contact a surface of the panel structure;
the first surface of the ring structure being brought into contact with the peripheral engagement surface of the nut as the nut is rotated on the fitting body structure, the engagement allowing some compensation movement for imperfections in the surface of the panel structure;
a circumferential cavity defined by the ring structure, a peripheral surface of the wall structure, the nut and outer peripheral surfaces of the body portion; and
a formed-in-place seal disposed within the cavity to provide a water-tight seal.

12. The fitting of claim 11, wherein:
the ring structure further includes at least one through opening communicating with the recess and formed through an outer periphery of the ring structure; and
the seal comprises a seal material dispensed through the at least one opening into the cavity in a liquid state and cured in place to a solid state.

13. The fitting of claim 12, wherein the seal material comprises a silicone.

14. The fitting of claim 12, wherein the seal material fills the cavity.

15. The fitting of claim 11, wherein:
the first surface of the ring structure is an angled surface; and
the peripheral engagement surface of the nut is angled in correspondence with the first surface of the ring structure and configured to contact the first surface of the ring structure as the nut is engaged with the body and turned to draw towards the panel structure and compensate irregularities in the panel structure so that the flange portion is fitted to the panel structure.

16. The fitting of claim 11, wherein the panel structure consists of a wall in the bathing installation.

17. The fitting of claim 11, wherein the panel structure includes a wall in the bathing installation and a flange structure positioned in an opening in the wall with the mount opening formed in the flange structure, the flange structure cooperating with the wall to emulate a recess in a bathing installation wall.

18. The fitting of claim 11, wherein the fitting body is fabricated of a transparent or translucent material, and includes a light receptacle configured to hold a light source and provide an illumination effect.

19. The fitting of claim 11, wherein the fitting body structure is a jet body, and includes a water inlet port.

20. A method for mounting and sealing a fitting in a mount opening in a panel structure in a bathing installation, comprising:
positioning a fitting body portion of a fitting body structure through the mount opening in the panel structure, the fitting body structure having a transverse flange portion with an outer size larger than the mount opening, so that the flange portion overlaps and contacts the panel structure surrounding the mount opening with the fitting body structure installed in the mount opening;
positioning a compensation ring structure onto the body portion of the fitting body structure from a panel structure side opposite the flange portion, the ring structure having an inner opening with a dimension larger than a size of the body portion;
engaging a nut structure with the body portion of the fitting body structure from the panel structure side opposite the flange portion, the nut having a peripheral engagement surface;
bringing the nut structure into contact with the ring structure such that the first surface of the ring structure contacts the peripheral engagement surface of the nut, so that a circumferential cavity is defined by the ring structure, a peripheral surface of the wall structure, the nut and outer peripheral surfaces of the body portion; and
dispensing a seal material through an opening in the ring structure into the cavity in a liquid state and allowing the seal material to cure in place to a solid state, to provide a water-tight seal.
